(19) United States
(12) Patent Application Publication
(10) Pub. No.: US 2008/0228595 A1
(43) Pub. Date: Sep. 18, 2008

(54) SYSTEM FOR SUPPORTING ELECTRONIC COMMERCE IN SOCIAL NETWORKS

(75) Inventors: Matthew Hill, Los Angeles, CA (US); Rhett McNulty, Santa Monica, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: SWAPEDO.COM, INC., Los Angeles, CA (US)

(21) Appl. No.: 11/685,727

(22) Filed: Mar. 13, 2007

(51) Int. Cl. G06Q 30/00

(52) U.S. Cl. 705/27

(57) ABSTRACT

A method for offering a plurality of items for commerce, wherein each of the items in the plurality of items includes an item identifier usable to reference that item. The method includes storing a first item identifier for the at least one of the plurality of items in a first predetermined location in a computer memory; associating a first image with the at least one of the plurality of items; and assigning a first name to the first image based on the first predetermined location in the computer memory. The method also includes creating a first reference link having the first name assigned to the first image; and, deploying the first reference link. A system for performing the method is also disclosed.

### BACKGROUND

1. Field

The present invention relates generally to electronic commerce systems, and more particularly, to a system for supporting electronic commerce in social networks.

2. Background

Social networking websites have become extremely popular. These websites allow users to create and post a personal profile online using one or more webpages hosted by the social networking website. Typically, these webpages contain certain sections into which a user can insert HyperText Markup Language (HTML) code. Electronic commerce sites allowing users to post and sell their own items (or items on which they receive a commission) have also become popular. However, the integration of the functionality provided by these two types of sites have been difficult.

For example, users may post Uniform Resource Identifier (URI) links referencing products for sale on a third-party site (e.g., a user may place HTML code on the webpages of their personal profiles that allow visitors to be directed to the webpage containing information about the product). However, these links, which are static in nature, require the user to update their personal profiles when the user wishes to change the item for sale or when the item is no longer available. Otherwise, when visitors attempts to access the products posted by the user, they will be directed to an item that is no longer for sale (e.g., an item that is being auctioned having been sold or the auction having expired). Thus, current systems do not provide the functionality of providing updated product references.

Further, creating attractive product listings on their personal profile pages usually requires users to learn HTML programming. The users also typically must gather the product information for the items they wish to sell, including any pictures or other graphics they desire to display on their store. In addition, the user has to find a location to store those elements, which is another item that the user has to maintain.

It would be desirable to address the deficiencies noted above.

### SUMMARY OF THE PREFERRED EMBODIMENTS

The present invention provides users the ability to add commerce capability (e.g., buy and sell goods and services) and syndicate product information to numerous social network third-party websites. In one preferred embodiment, the present invention is embodied in a system having a computer including a processor and a memory coupled to the processor, wherein the memory including computer-readable code that, when executed, will cause the processor to perform a method for offering a plurality of items for commerce, wherein each of the items in the plurality of items includes an item identifier usable to reference that item. The method includes storing a first item identifier for the at least one of the plurality of items in a first predetermined location in a computer memory; associating a first image with the at least one of the plurality of items; and assigning a first name to the first image based on the first predetermined location in the computer memory. The method also includes creating a first reference link having the first name assigned to the first image; and, deploying the first reference link.

In another preferred embodiment, the present invention is embodied in a method for offering a plurality of items for commerce, wherein each of the items in the plurality of items includes an item identifier usable to reference that item, the method including storing a first item identifier for the at least one of the plurality of items in a first predetermined location in a computer memory; associating a first image with the at least one of the plurality of items; and assigning a first name to the first image based on the first predetermined location in the computer memory. The method then includes creating a first reference link including the first name assigned to the first image; and, deploying the first reference link.

In yet another preferred embodiment, the present invention is embodied in an apparatus having a computer-readable medium with instructions stored thereon that, when executed by a computer, causes the computer to execute a method for offering a plurality of items for commerce, wherein each of the items in the plurality of items includes an item identifier usable to reference that item. The method includes storing a first item identifier for the at least one of the plurality of items in a first predetermined location in a computer memory; associating a first image with the at least one of the plurality of items; and assigning a first name to the first image based on the first predetermined location in the computer memory. The method then includes creating a first reference link including the first name assigned to the first image; and, deploying the first reference link.

Other objects, features and advantages will become apparent to those skilled in the art from the following detailed description. It is to be understood, however, that the detailed description and specific examples, while indicating exemplary embodiments of a social commerce deployment network, are given by way of illustration and not limitation. Many changes and modifications within the scope of the following description may be made without departing from the spirit thereof, and the description should be understood to include all such variations.

### BRIEF DESCRIPTION OF THE DRAWINGS

The invention may be more readily understood by referring to the accompanying drawings in which:

FIG. 1 is a block diagram illustrating a system for implementing commerce for social networks configured in accordance with one preferred embodiment of the present invention;

FIG. 2 is a block diagram of a computer system configured in accordance with one preferred embodiment of the present invention;

FIG. 3 is a flow diagram of a social network commerce implementation process configured in accordance with one preferred embodiment of the present invention;

FIG. 4 is a flow diagram of a catalogue builder process configured in accordance with one preferred embodiment of the present invention;

FIG. 5 is a screenshot of a catalogue builder graphical user interface (GUI) configured in accordance with one preferred embodiment of the present invention;

FIG. 6 is a screenshot of the catalogue builder GUI of FIG. 5 after a search has been performed on a product information database in accordance with one preferred embodiment of the present invention;

FIG. 7 is a screenshot of the catalogue builder GUI of FIG. 5 after a store listing has been imported in accordance with one preferred embodiment of the present invention;

FIG. 8 is a screenshot of a catalogue built using the catalogue builder GUI of FIG. 5 in accordance with one preferred embodiment of the present invention;

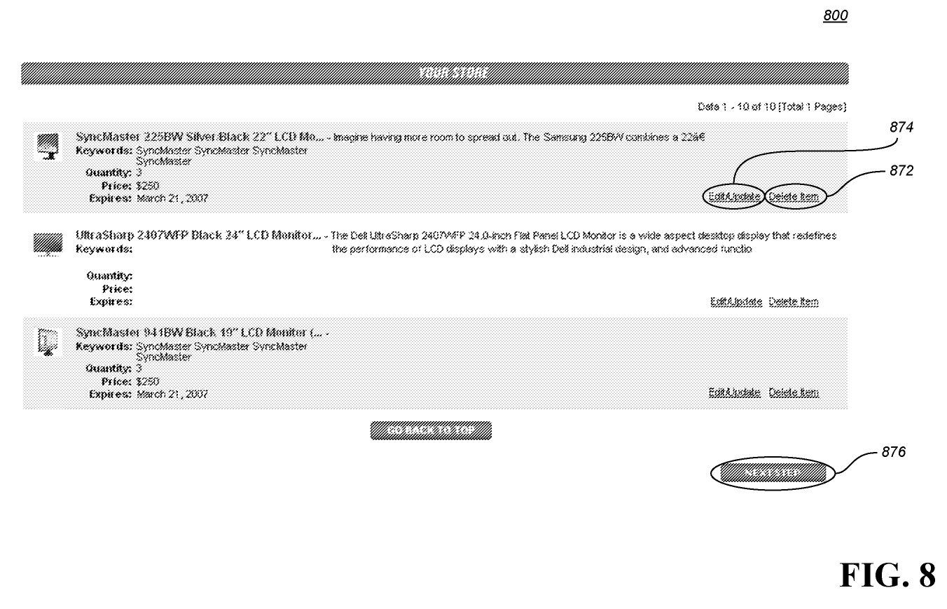

FIG. 9 is a flow diagram of a mini-store builder process configured in accordance with one preferred embodiment of the present invention;

FIG. 10 is a screenshot of a mini-store builder GUI configured in accordance with one preferred embodiment of the present invention;

FIG. 11 is a screenshot of a user mini-store being configured using the mini-store builder GUI of FIG. 10 in accordance with one preferred embodiment of the present invention;

FIG. 12 is a screenshot of a second version of the user mini-store of FIG. 11 having been updated using the mini-store builder GUI of FIG. 10 in accordance with one preferred embodiment of the present invention;

FIG. 13 is a screenshot of a mini-store placement tool GUI configured in accordance with one preferred embodiment of the present invention for deploying the user mini-store that was created using the mini-store builder GUI of FIG. 10;

FIG. 14 is a flow diagram of the mini-store placement tool process configured in accordance with one preferred embodiment of the present invention for deploying the user mini-store on a third-party website;

FIG. 15 is a screenshot of the mini-store placement tool GUI configured in accordance with another preferred embodiment of the present invention for deploying the user mini-store on a third-party website;

FIG. 16 is a screenshot of the mini-store placement tool GUI configured in accordance with another preferred embodiment of the present invention for deploying the user mini-store in an e-mail message;

FIG. 17 is a screenshot of the mini-store placement tool GUI of FIG. 15 where a pull-down menu with options specific to the third-party website is displayed;

FIG. 18 is a screenshot of the user mini-store of FIG. 12 as deployed on the third-party website in accordance with one preferred embodiment of the present invention;

FIG. 19 is a flow diagram of a item detail information retrieval process configured in accordance with one preferred embodiment of the present invention;

FIG. 20 is a screenshot of an item detail information display GUI configured in accordance with one preferred embodiment of the present invention;

FIG. 21 is a screenshot of a store home page GUI for the user configured in accordance with one preferred embodiment of the present invention.

Like numerals refer to like parts throughout the several views of the drawings.

### DETAILED DESCRIPTION OF THE PREFERRED EMBODIMENTS

In one preferred embodiment of the present invention, a mechanism referred to as a “mini-store” is used to allow users to add commerce capabilities to their personal webpages on third-party websites such as social network websites. The mini-stores provide small dynamic sections on their webpages to allow users to offer items for sale or trade. To add a mini-store to a third-party website, a user will add lines of HyperText Markup Language (HTML) code to the source file of the user's personal page on the third-party website.

For example, websites such as myspace.com or friendster.com allow users to edit the HTML code that is displayed on their profile page. Mini-stores may be deployed on any website that allows users to insert their own custom HTML code. After the code has been added, the mini-store will display items that the user wishes to sell or trade and be dynamically updatable. Through the use of the mini-store, users will attract others to view all the items they have for sale. The present invention also allows users to create and manage multiple mini-stores that can be customized for various third-party sites. For example, each customized version of a mini-store will include a different predetermined set of items selected from a product catalogue. These mini-stores act as portals from the third-party site to the user's complete store.

Mini-stores are also displayable in e-mail, instant messaging (IM), short messaging service (SMS) and other applications where web-based code may be displayed. For example, the user can display a mini-store in the content (e.g., body or signature area) of their e-mails. A user may also display a mini-store in a SMS message. Similar to the implementation of a mini-store on a third-party website, the displayed mini-store will include a link to allow a recipient of the message to go to a complete store website where the full list of items (and their details) may be viewed.

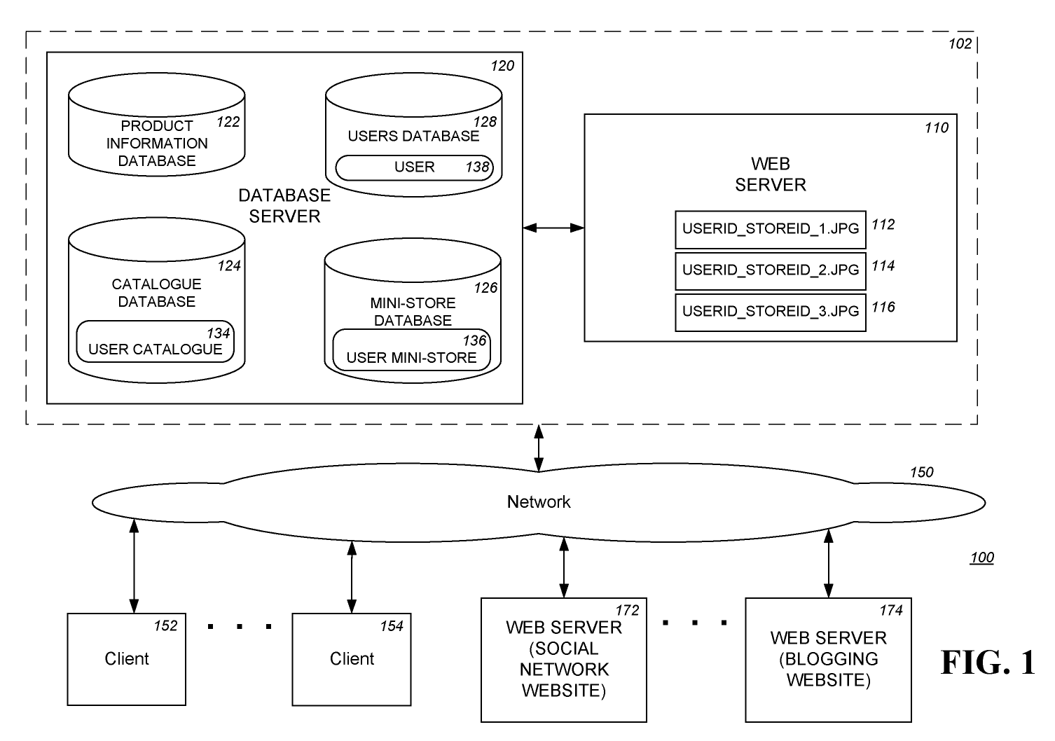

FIG. 1 illustrates a system architecture 100 in which one preferred embodiment of the present invention may be implemented, including a server system 102 having a web server 110 and a database server 120. A client 152 and a client 154 are coupled for communications with the server system 102 through a network 150. Multiple server systems and clients, as well as other computer systems may also be coupled to the server system 102 through the network 150. For example, FIG. 1 also shows a web server 172 hosting a social network website and a web server 174 hosting a blogging website coupled to the network 150. Other web servers hosting other types of websites, although not shown, may be coupled for communication with the systems connected to the network 150. As described herein, a user, using software on a client computer such as a browser application on the client 152, interacts with the server system 102.

The network 150 represents a variety of networks that may include one or more local area networks as well as wide area networks. The functionality provided by the web server 110, the database server 120, the client 152 and the client 154, as well as by any other computer systems necessary in the network 150, may be implemented using a computer system having the characteristics of the computer system described herein. It should be noted, however, that the specific implementation of the computer system or systems used to describe the present invention is not to be limiting unless otherwise specifically noted. For example, the functionality provided by the web server 110 and the database server 120 may be provided by one computer system. Further, the functionality provided by the web server 110 and the database server 120 may be distributed over several computer systems.

In one preferred embodiment of the present invention, the database server 120 is implemented as a relational database management system that support the Structured Query Language (SQL) standard as adopted by the American National Standards Institute (ANSI) and the International Organization for Standardization (ISO) to create, retrieve, update and delete data. As part of the description, terms such as “foreign key” and “table” will be used. In the context of relational databases, a table is a set of data elements (values) that is organized using a model of horizontal rows and vertical columns. The columns are identified by name, and the rows are identified by the values appearing in a particular column subset that has been identified as a candidate key, which is a field or combination of fields that can act as a primary key field for that table to uniquely identify each row, or “record,” in that table. A foreign key is a referential constraint between two tables. The foreign key identifies a column or a set of columns in one (referencing) table that refers to a column or set of columns in another (referenced) table. The columns in the referenced table must form a primary key or unique key. The values in one row of the referencing columns must occur in a single row in the referenced table. Thus, a row in the referencing table cannot contain values that do not exist in the referenced table. This way references can be made to link information together and it is an essential part of database normalization. Multiple rows in the referencing table may refer to the same row in the referenced table. Further, it should be noted that the terms “database” and “table” (both in their singular and plural form) are used interchangeably to indicate the grouping of data and does not indicate the actual configuration of the storage of the data. Thus, although the description contained herein mentions data stored in multiple databases, the data may be consolidated in one database or may be spread over multiple databases configured differently from the version described herein.

In one preferred embodiment of the present invention, the database server 120 includes a product information database 122, a catalogue database 124, a mini-store database 126 and a user database 128. These databases are used to store the information necessary for the implementation of the various described embodiments of the invention. For example, the catalogue database 124 stores information related to one or more user created catalogues in tables such as a user catalogue 134; the mini-store database 126 stores information related to one or more mini-stores in records such as a user mini-store record 136; and the user database 128 stores information related to one or more user in records such as a user record 138.

A web server program is executed on the web server 110 to performs the web server functionality described herein, including receiving requests for retrieving or posting information from client computers (e.g., request for files or webpages, or request to post data); interacting with the database server 120 to retrieve or store any information based on the received requests; and generating and transmitting the necessary information to fulfill those requests (e.g., transmitting files or information necessary for rendering webpages, or confirmation that the data was stored).

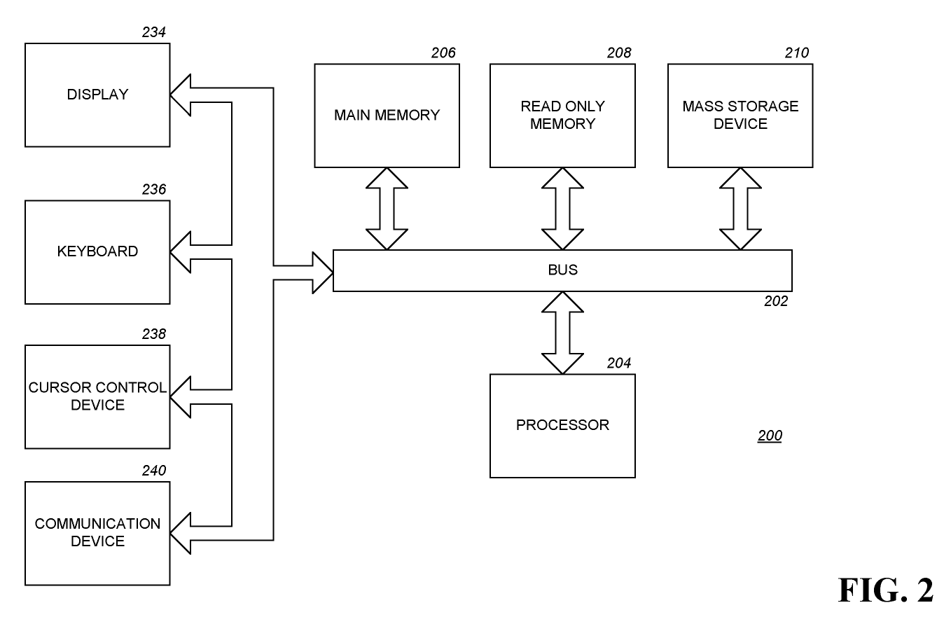

FIG. 2 illustrates an example of a computer system 200 in which the features of the present invention may be implemented. The computer system 200 includes a bus 202 for communicating information between the components in the computer system 200, and a processor 204 coupled with the bus 202 for executing software code, or instructions, and processing information. The computer system 200 further comprises a main memory 206, which may be implemented using random access memory (RAM) and/or other random memory storage device, coupled to the bus 202 for storing information and instructions to be executed by the processor 204. The main memory 206 also may be used for storing temporary variables or other intermediate information during execution of instructions by the processor 204. The computer system 200 also includes a read only memory (ROM) 208 and/or other static storage device coupled to the bus 202 for storing static information and instructions for the processor 204.

A communication device 240 is also coupled to the bus 202 for accessing other computer systems, as described below. The communication device 240 may include a modem, a network interface card, or other well-known interface devices, such as those used for interfacing with Ethernet, Token-ring, or other types of networks. In this manner, the computer system 200 may be coupled to a number of other computer systems.

A mass storage device 210, such as a magnetic disk drive and/or a optical disk drive, may be coupled to the computer system 200 for storing information and instructions. The computer system 200 can also be coupled via the bus 202 to a display device 234, such as a cathode ray tube (CRT) or a liquid crystal display (LCD), for displaying information to a user so that, for example, graphical or textual information may be presented to the user on the display device 234. Typically, an alphanumeric input device 236, including alphanumeric and other keys, is coupled to the bus 202 for communicating information and/or user commands to the processor 204. Another type of user input device shown in the figure is a cursor control device 238, such as a conventional mouse, touch mouse, trackball, track pad or other type of cursor direction key for communicating direction information and command selection to the processor 204 and for controlling movement of a cursor on the display 234. Various types of input devices, including, but not limited to, the input devices described herein unless otherwise noted, allow the user to provide command or input to the computer system 200. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, the computer system 200 may optionally include such devices as a video camera, speakers, a sound card, or many other conventional computer peripheral options.

As noted herein, the user may interact with the information stored in the server system 102 through browser software in the client 152. The browser presents a graphical user interface (GUI) to the user. In the following description, the GUI is implemented using one or more webpages (which may be referred to as “pages,” “screens,” or “forms”) provided by the web server 110 accessible by the user using any Internet web browser software, such as the Internet Explorers browser provided by Microsoft Corp., on a client computer such as the client 152. In another embodiment, one or more custom software programs can be created to implement the system described herein. Of course, the web server 110 may itself have browser software installed on it so as to be accessed by a user. Further, throughout the description of the various embodiments of the invention herein, references are made to the user performing such actions as selecting buttons, inputting information on forms, executing searches or updates on the database server 120. In one preferred embodiment, these actions are generated by the user during the user's interaction with the browser. For example, one or more pages described herein includes forms that include fields in which the user may type. Once the user has provided such data, the user may select a button or link on the page to submit the information and cause an update of the database server 120 with the information. The browser will send the web server 110 the information retrieved from the user using the form, which will cause the information stored on the web server 110 and the database server 120 to be updated.

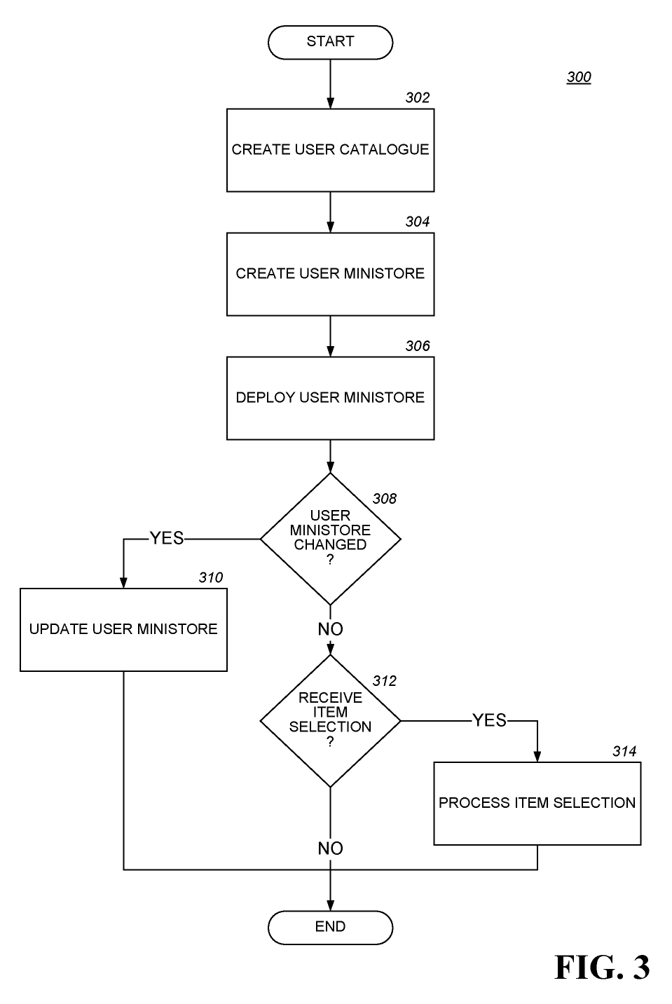

FIG. 3 illustrates a social network commerce deployment process 300 configured in accordance with one preferred embodiment of the present invention where, in step 302, a user first creates a product catalogue such as a user catalogue 134 that is stored in the catalogue database 124. Specifically, the user builds a catalogue of products that the user wishes to offer to other peers. Then, in step 304, the user creates a user mini-store record 136 in the mini-store database 126. Finally, in step 306, the user deploys the user mini-store in the social network.

The user mini-store is dynamically updatable based on the user changing or updating the user mini-store and/or the product catalogue with which the mini-store is associated even after the user mini-store has been deployed. In addition, the system allows the deployment of multiple, independent user mini-stores whether they are based on the same or different product catalogues. Thus, for example, the user may build a mini-store with products that are specifically catered to be displayed on one specific website, such as mountaineering gear for a website discussing mountaineering.

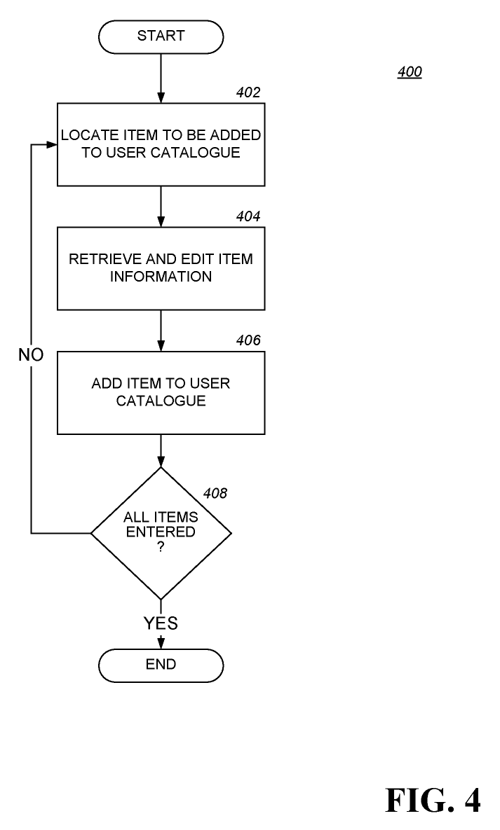

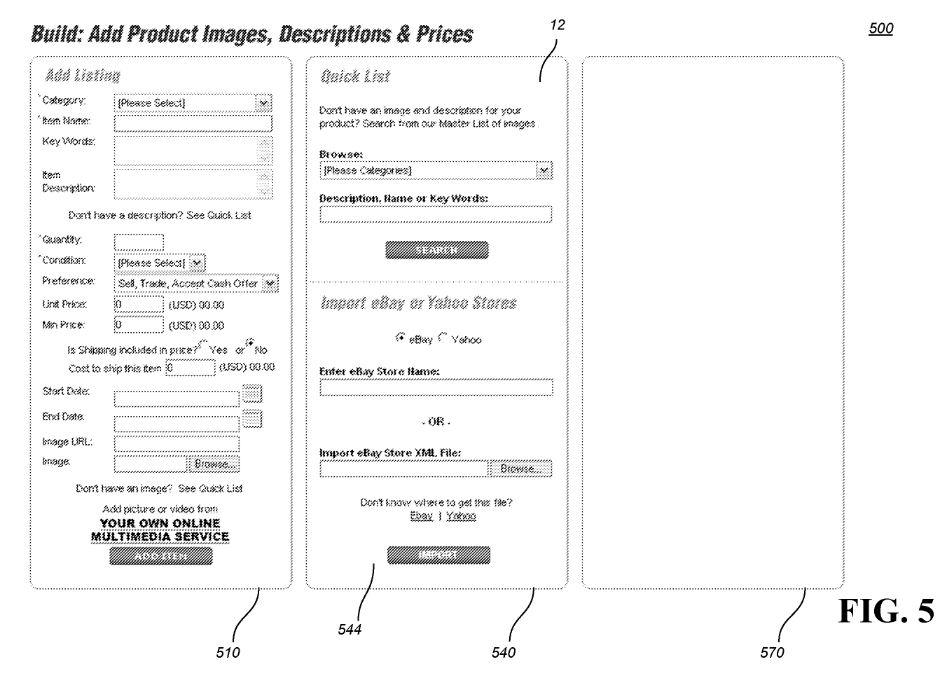

In step 302 of the social network commerce deployment process 300 as shown in FIG. 3, the user creates a product catalogue in accordance with a catalogue building process described with reference to FIG. 4, which illustrates a catalogue building process 400 configured in accordance with one preferred embodiment of the present invention. In describing the catalogue building process 400, reference will be made to FIG. 5, which illustrates a catalogue builder GUI 500 configured in accordance with one preferred embodiment of the present invention that may be used in the catalogue building process 400. It should be noted that although the catalogue building process 400 described herein specifically emphasizes the building of a catalogue containing products, the process can equally be applicable to the building of a catalogue of services as well. Thus, a services catalogue or catalogues of other types may be created. Further, it is contemplated that catalogues may be built that includes a mix of products, services, or other items of interest.

In step 402, information for an item or “listing” to be added to the user catalogue 134 is located. Several mechanisms are disclosed herein for the user to locate the item to be added, which may be bypassed if the user wishes to manually add a listing. In one preferred embodiment of the present invention, the catalogue builder GUI 500 of FIG. 5 includes three main sections: an add listing section 510, a quick entry section 540, and, a quick entry listing section 570. Each of these sections will now be described as a part of step 404, during which information for the item to be added is retrieved and edited.

The add listing section 510 contains various text entry fields in which the user may enter/edit detailed information for a particular product to be entered into the user catalogue 134. In one preferred embodiment of the present invention, certain information are required from the user for each listing to be entered into the user catalogue 134. These include a product category, including one or more subcategories, to which the item belongs; an item name; a quantity of the item being offered; and a condition rating of the item being offered (e.g., new or used). The user may use the add listing section 510 to directly add a listing if the user has the minimum required information.

The quick entry section 540 allows the user to locate or retrieve item information from another source as an alternative to entering the information manually. In one preferred embodiment of the present invention, the quick entry section 540 includes two subsection: a quick list subsection 542 and a store import subsection 544. As illustrated in the quick list subsection 542, the user can search for product information based on a description, name or key words in a query that is run against the product information database 122 contained in the database server 120. The key word can be based on standardized product references, including a reference conforming to the Universal Product Code (UPC), European/Japanese Article Number (EAN/JAN), Global Trade Item Number (GTIN), or International Standard Book Number (ISBN) coding systems. In addition to performing a search, the user can also browse through the product information database 122 to select a particular item to be added. In addition to retrieving product information from the product information database 122, the user can also import information from an existing store catalogue using the store import subsection 544. In the illustrated example, the user can import the user's store information from eBay™ or Yahoo™ by using an extensible Markup Language (XML) file that is exported from the respective service.

The quick entry listing section 570 is used to display product listing information based on either the searching or browsing performed by the user in the quick list subsection 542, or the importing of store information from the store import subsection 544. In one preferred embodiment of the present invention, quick entry listing 570 is blank when the catalogue builder GUI 500 is initially displayed before any searches or imports has been performed by the user, as illustrated in FIG. 5. In another preferred embodiment of the present invention, messages (e.g., help or news) may be displayed in quick entry listing 570.

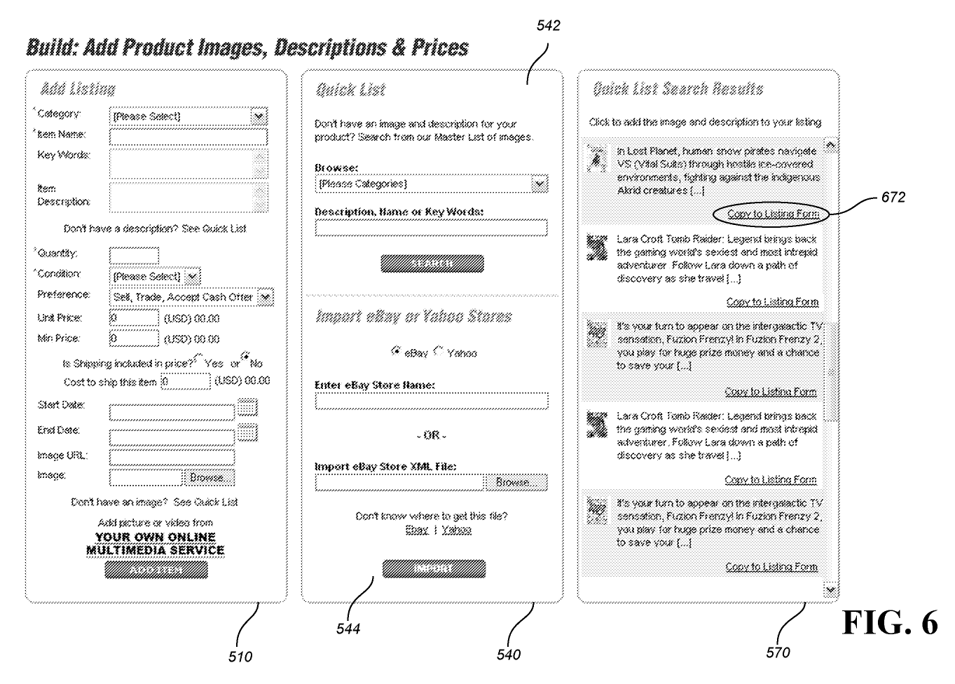

FIG. 6 illustrates the quick entry listing section 570 of the catalogue builder GUI 500 having been updated where the user has searched for a product in the quick list subsection 542. Associated with each of the search results is a “Copy to Listing Form” link such as a copy listing link 672 that the user can select to copy the product information for the item of interest over to the respective fields in the add listing section 510. The user can then edit the information that has been copied over.

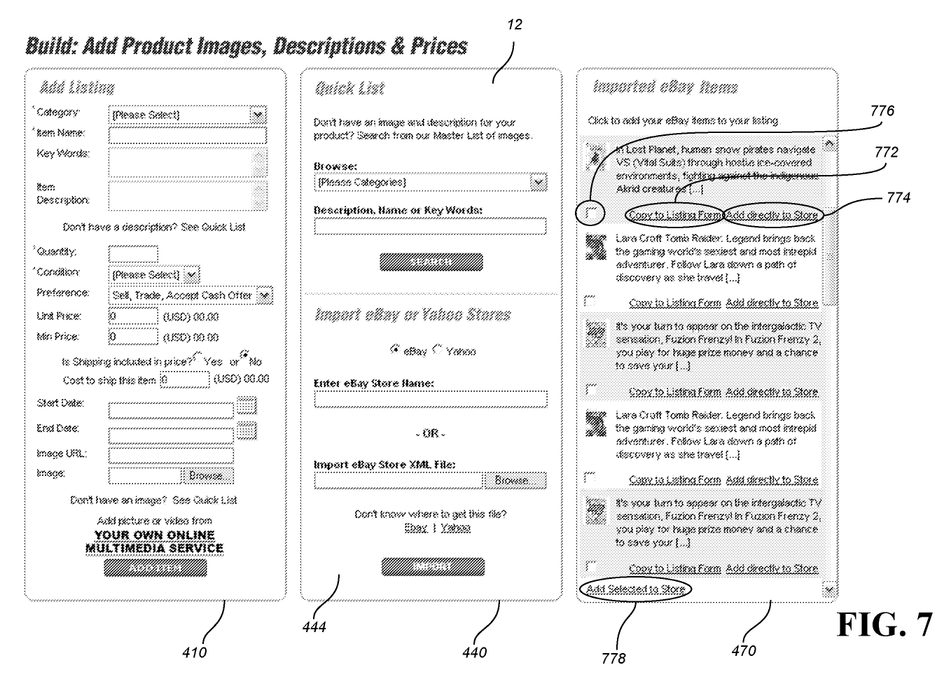

FIG. 7 illustrates the quick entry listing section 570 of the catalogue builder GUI 500 having been updated where the user has imported a store listing using store import subsection 544. Associated with each of the search results is a “Copy to Listing Form” link such as a copy listing link 772 that the user can select to copy the product information for the item of interest over to the respective fields in the add listing section 510. The user can then edit the information that has been copied over. In addition, an “Add directly to store” link such as a direct store addition link 774 is associated with each of the listings so that the user can add the product associated with the link directly to the user catalogue 134 when the user does not need to edit the item descriptions. A check box such as a check box 776 is also associated with each product listing to allow the user to add multiple items to the user catalogue 134. Specifically, the user can select each check box and then select an “Add selected to store” link 778 to add all of the selected items to the user catalogue 134. This feature allows for the user to add items to the catalogue in bulk.

Once the user has located the item to be added to the user catalogue 134, and retrieved and edited the information related to the item using one of the mechanism described above, the item will be added to the user catalogue 134 in step 406. This includes the creation of a record in the user catalogue 134 to store the information of the added item, with a unique identifier being used to retrieve the information after the item has been added. In one preferred embodiment of the present invention, the table for the catalogue database 124 contains the following columns, not all of which are necessary as discussed herein:
ItemID: Identifier of record (unique).
Name: Name of listing.
Keywords: Keywords used to describe listing.
Description: Description of listing.
Price: Price of listing.
Quantity: Quantity of items in listing offered.
ShippingPrice: Shipping price for the item.
FromDate: Start date of the listing.
ExpireDate: Expiration date of the listing.
ImageId: Unique identifier for an image.
ImageURL: The URL for the location of the image.
CategoryIdLevel1: The identifier for category level 1.
CategoryIdLevel2: The identifier for category level 2.
CategoryIdLevel3: The identifier for category level 3.
CategoryTextLevel1: The text for category level 1.
CategoryTextLevel2: The text for category level 2.
CategoryTextLevel3: The text for category level 3.
BarterType: The type of bartering transaction that can be performed for this listing, such as cash and another item, or item only.
NumberOfViews: The number of times the listing has been viewed.
DateUploaded: The date the listing was uploaded.
Condition: The condition of the listing.
UserId: The unique identifier of the user adding the product.
MinPrice: The minimum price acceptable to the user for the listing (e.g., a minimum bid price for an auction listing).

If no additional listings are to be added in step 408, then operation ends. Otherwise, operation returns to step 402, where information for another listing to be added may retrieved and added to the user catalogue 134.

Referring again to the social network commerce deployment process 300 in FIG. 3, after the user has created a product catalogue such as the user catalogue 134 in step 302, the user can create one or more mini-stores in step 304 that can be deployed in the manner as described herein to create a social network commerce system.

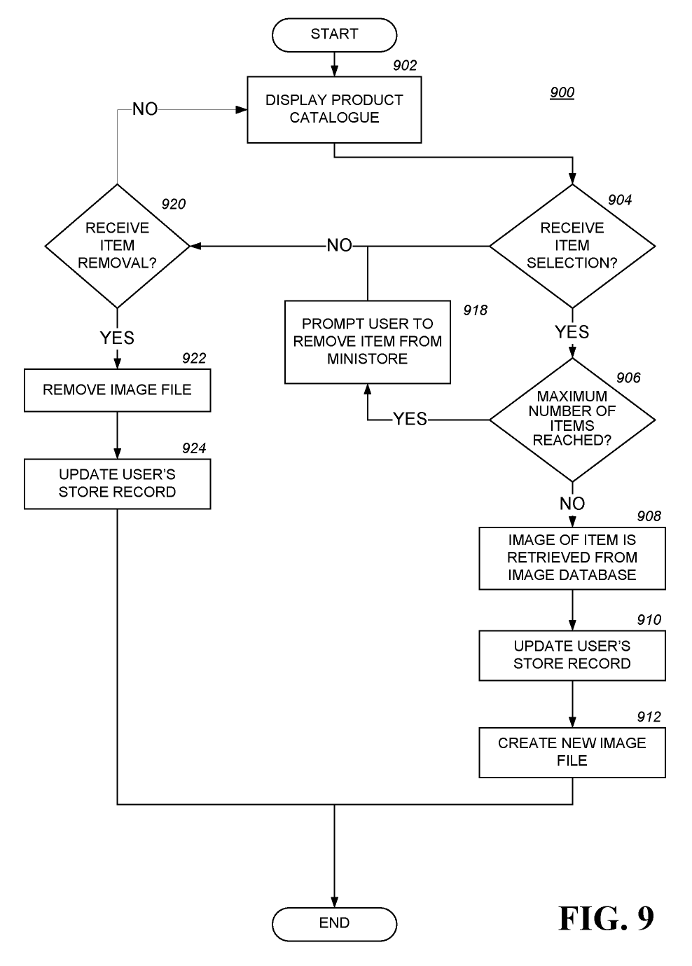

FIG. 9 illustrate a mini-store building process 900 for the building of a mini-store where, in step 902, a product catalogue such as the user catalogue 134 is displayed to allow the user to choose the items to be included in the mini-store. In one preferred embodiment, the user catalogue 134 is displayed as a listing and the user can perform standard list management functions to search, sort, or filter the listing to locate an item of interest. One or more items may then be added from the user catalogue 134 into the user mini-store record 136, as further described herein.

In step 904, the system detects whether the user has selected an item to add to the user mini-store record 136. If so, operation continues with step 906. Otherwise, operation continues with step 920.

In step 906, the system determines if a maximum number of items to be included in the user mini-store record 136 has already been reached. In one preferred embodiment of the present invention, each mini-store is limited to three (3) items. In another preferred embodiment of the present invention, there are no limitations to the number of items that can be included in a mini-store. If the maximum number of items has not already been reached in the user mini-store record 136, then operation continues with step 908. Otherwise, operation continues with 918.

In one preferred embodiment of the present invention, each user mini-store record in the mini-store database 126 is created based on a database table having the following columns: Mini-storeID, UserID, ItemID1, ItemID2 and ItemID3, wherein Mini-storeID is a primary key (i.e., a unique identifier) for each mini-store record in the mini-store database 126; UserID is a foreign key to the UserID from the user table in the user database 128 (i.e., UserID is a unique identifier that is assigned to each user); and ItemID1, ItemID2 and ItemID3, each of which is the identifier for one of the three item images that are associated with the particular mini-store. Each one of ItemID1, ItemID2 and ItemID3 also includes the foreign key to a specific item identifier in the user catalogue 134 of the catalogue database 124.

In step 908, the item image associated with the item selected by the user is retrieved. In one preferred embodiment of the present invention, the item image as well as any item information that needs to be retrieved is based on the item identifier assigned to the item selected by the user, where the item identifier is the unique identifier that is assigned to each item in the user catalogue 134, as discussed above.

In step 910, the item identifier determined in step 908 is stored into the user mini-store record 136 in the mini-store database 126. In one preferred embodiment of the present invention, where each mini-store can contain up to three (3) items and there are three columns in the user mini-store record 136, the item identifier will be placed into the first available ItemID column (i.e., ItemID1, ItemID2 or ItemID3) in the user mini-store record 136. For example, if the mini-store record 136 only contains one existing item (i.e., the mini-store record 136 contains an item identifier only in ItemID1), then the item identifier for the item to be added will be placed into ItemID2. In another preferred embodiment of the present invention, the user may select the position and order of each of the items displayed in the mini-store.

In step 912, a copy of the item image retrieved in step 908 is created and saved on the web server 102. In one preferred embodiment of the present invention, the item image file for the retrieved item image is named according to the following naming convention:

### UserID_Mini-storeID_n.jpg

where UserID is the unique identifier assigned to the user (e.g., the foreign key for the user record 138 in users database 128), the Mini-storeID is the unique identifier assigned to the mini-store (e.g., the foreign key for the user mini-store record 136 in mini-store database 126), and n is the number of the column in the user mini-store record 136 in which the item identifier related to the item image is stored (e.g., a number from 1 to 3, corresponding to ItemID1, ItemID2, or ItemID3). FIG. 1 illustrates the web server 102 storing three exemplary image files 112, 114 and 116 with generic names based on the description provided herein. For example, where the user has a UserID of 10232 and a Mini-storeID of 29, then the created file name for the image associated with the product stored in ItemID1 of the user mini-store record 136 is 10232_{—}29_{—}1.jpg.

In step 920, where the system has not received a selection from the user to add an item to the user mini-store record 136, it is determined if the user is removing an item from the user mini-store record 136. If not, then operation returns to step 902. Otherwise, if the system receives a selection from the user to remove an item from the user mini-store record 136, operation will continue with step 922.

In step 922, the image file associated with the item to be removed from the user mini-store record 136 is deleted from the web server 102. In another preferred embodiment of the present invention, instead of deleting the image file, it is replaced with a substitute image, such as an image that is completely blank or an image of the user's choosing, such as a mini-store logo. Operation then continues with step 924.

In step 924, the user mini-store record 136 is updated to remove the item identifier from the column associated with the removed item. In one preferred embodiment of the present invention, a predetermined number, such as a number representing a null item identifier (e.g., “000000”), is placed into the column associated with the removed item. In another preferred embodiment of the present invention, no value is placed into the slot and the content of the particular ItemID column is left as null. The use of a null item identifier allows the web server 120 to process the request the selection of the item by a visitor in a special manner. For example, the web server 120 can return a home page of the user that includes all the items the user has for sale when it detects a request for an item with an associated null item identifier.

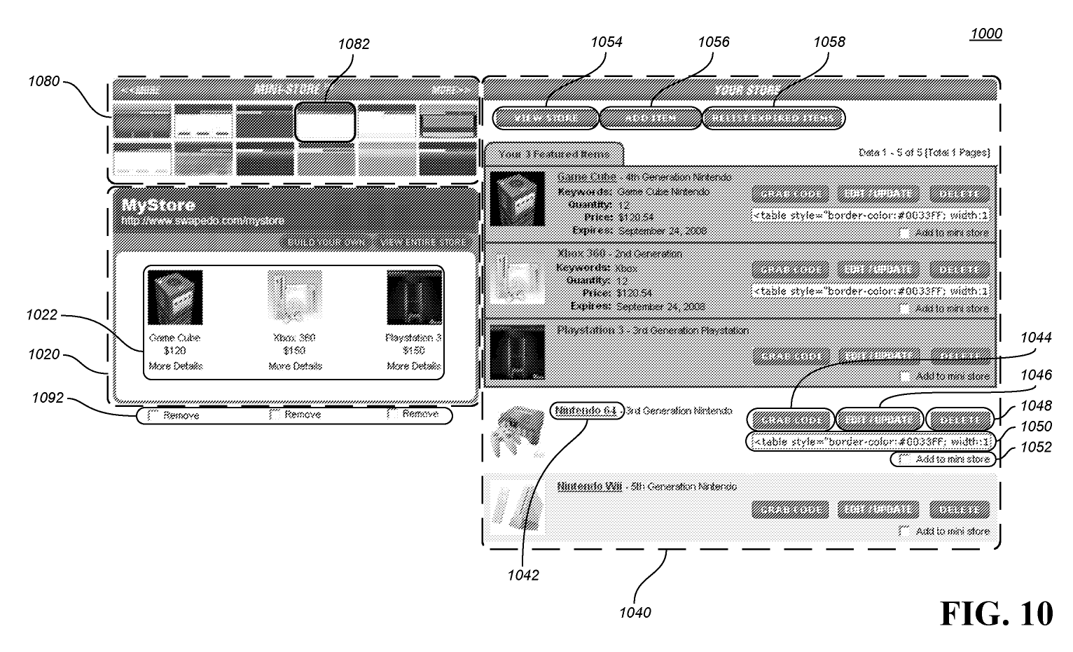

FIG. 10 illustrates a mini-store builder GUI 1000 configured in accordance with one preferred embodiment of the present invention. Mini-store builder GUI 1000 includes a mini-store preview section 1020; a product listing section 1040; and a mini-store template selector 1080. The mini-store builder GUI 1000 also includes a plurality of item removal check boxes 1092. The mini-store preview section 1020 provides a preview of what a mini-store created by the user will look like, including the items that have been selected by the user to be listed in the mini-store, such as a plurality of selected items 1022. Each of the plurality of item removal check boxes 1092 may be used to remove a corresponding item in the plurality of selected items 1022, as discussed above with reference to FIG. 9. In one preferred embodiment of the present invention, the mini-store template selector 1080 includes a plurality of graphic templates such as a template 1082 that can be applied to the mini-store.

The product listing section 1040 lists the items in the user catalogue 134 and includes a view store button 1054, which the user can select to view the user catalogue 134; an add item button 1056, which is used to add further items to the user catalogue 134; and a relist expired items button 1058. In one preferred embodiment of the present invention, each item in the user catalogue 134 has an associated period during which it is valid. Once each period has been reached, the respective item is marked as “expired” to prevent the user catalogue 134 from becoming stale. In one preferred embodiment of the present invention, an expired item would remain in the mini-store of the user if it has been placed into the mini-store before it was expired, but be made unavailable for sale until the user reactivated the item. In another preferred embodiment of the present invention, the mini-store would be updated to replace the expired item with the next item in the catalogue of the user. In yet another embodiment of the present invention, the item could be replaced with a “null” item (e.g., the item identifier for the expired item can be replaced with a null identifier) such that the default user page (e.g., the store home page of the user) may be displayed. Further, one or more e-mails may be sent to the user to notify the user that the item has expired.

Each listing in the product listing section 1040 also includes an item detail link 1042, through which an item detail page may be accessed when the link is selected by the user; a grab code button 1044; an edit/update button 1046, which allows the user to edit or update the information pertaining to the particular item entry in the product catalogue 134; a delete button 1048, which allows the user to remove the item from the listing; a code display field 1050; and an add to mini-store checkbox 1052, which allows the user to add the item to the mini-store, as discussed herein. The grab code button 1044 and the code display field 1050 will be further detailed herein.

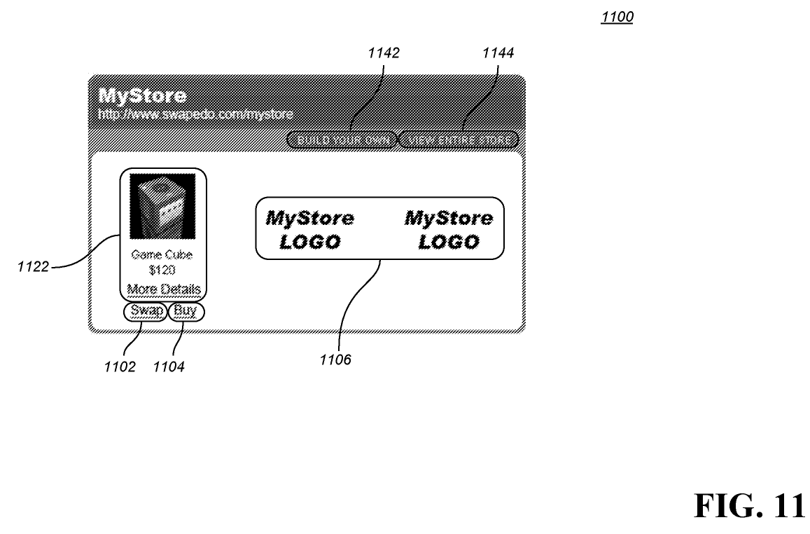

FIG. 11 illustrates an exemplary user mini-store GUI 1100 as configured using the mini-store builder GUI 1000 in accordance with one preferred embodiment of the present invention. The exemplary user mini-store GUI 1000 as shown includes one item that has been added to the mini-store, which includes: an item detail link 1022 that will take the user to the item detail page when selected by the user; a swap link 1002 that will bring the user to a page to swap for the item; and a buy link 1004 that will bring the user to a page to buy the item. In one preferred embodiment of the present invention, if there are fewer than three (3) items in the mini-store, a logo such as a logo 1006 will be displayed in lieu of a blank image.

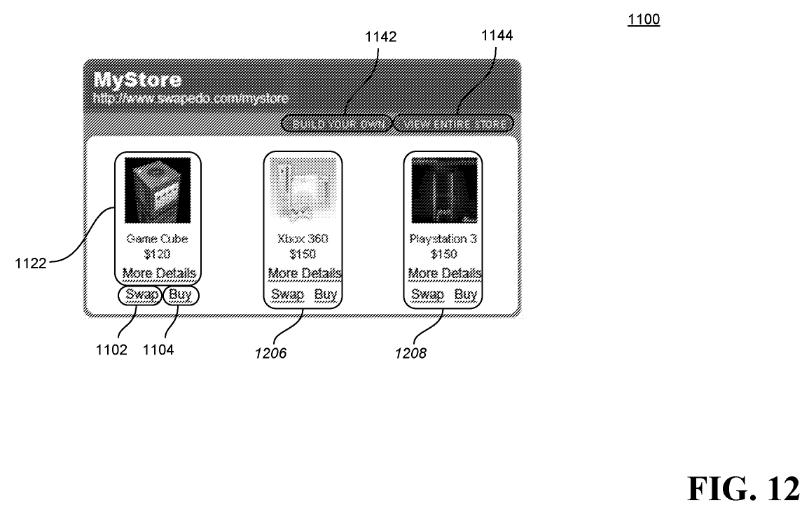

FIG. 12 illustrates the exemplary user mini-store GUI 1100 as updated using the mini-store builder GUI 1000 in accordance with one preferred embodiment of the present invention. The exemplary user mini-store GUI 1100 as shown in FIG. 12 includes two additional items 1206 and 1208 that have been added to the mini-store, each of which also includes an item detail link, a swap link, and a buy link.

Although the mini-store building process described above details a manual configuration process by the user whenever a mini-store is first created, it should be noted that a mini-store may automatically be created immediately for the user after the user has created a user catalogue. For example, a mini-store may be auto-populated with three (3) items from the user catalogue 134 based either on a predetermined or random selection process.

Once the user has created the mini-store in step 304, step 306 of the social network commerce implementation process 300 provides for the deployment of the mini-store. As described herein, a mini-store may be deployed into a social network through several mechanisms. Initially, the most simple example will involve the user cutting and pasting the code needed to render the mini-store (e.g., the contents of the user mini-store record 136) to be displayed on a webpage. In one preferred embodiment of the present invention, the code is static HTML code. For example, the HTML code for displaying the image and associated link of an item referenced by the item identifier in ItemID1 field in the user mini-store record 136, where the user has a UserID of 10232 and a Mini-storeID of 29, is:

<a href=“http://www.swapedo.com/index.php?Action=Main.MiniStore&image=10232_{—}29_{—}1.jpg”><img src=“http://www.swapedo.com/images/ministore/10232_{—}29_{—}1.jpg”/></a>,
where index.php is a script written in accordance with the PHP: Hypertext Preprocessor (PHP) scripting standard as provided by The PHP Group at http://www.php.org, and where the Main.MiniStore function of the index.php script, when executed, will first extract the proper item identifier for the item to be displayed. In one preferred embodiment of the present invention, the item identifier is extracted by retrieving the user mini-store record associated with the Mini-storeID of 29 (e.g., the user mini-store record 136) from the mini-store database 126 and the item identifier stored in the ItemID1 field of the record.

Similarly, the HTML code for displaying the images and associated links of the items in ItemID2 and ItemID3 are:

<a href=“http://www.swapedo.com/index.php?Action=Main.MiniStore&image=10232_{—}29_{—}2.jpg”><img src=“http://www.swapedo.com/images/ministore/10232_{—}29_{—}2.jpg”/></a>, and,
<a href=“http://www.swapedo.com/index.php?Action=Main.MiniStore&image=10232_{—}29_{—}3.jpg”><img src=“http://www.swapedo.com/images/ministore/10232_{—}29_{—}3.jpg”/></a>,
respectively. The other HTML code necessary to generate the mini-store, such as the HTML code used to lay out the item images or the displayed border, is not shown.

The above code is static, so it is valid in websites that filter dynamic HTML code. However, the code will load images from the web server 110, which may send a different version every time the image is served from the web server 110. As described above, when the user creates the user mini-store record 136, the user creates 3 images (which are stored on the web server 110). These images are loaded based on the mini-store static HTML code. Since the image name never changes, it means that the mini-store static HTML code will never change. However, when the user updates the mini-store record 136, one or more of the images created by the user is updated. Thus, when the mini-store static HTML code is reloaded, such as when the webpage on which the mini-store is stored is reloaded, the images for the updated items are reloaded as well and will reflect the updated contents of the mini-store.

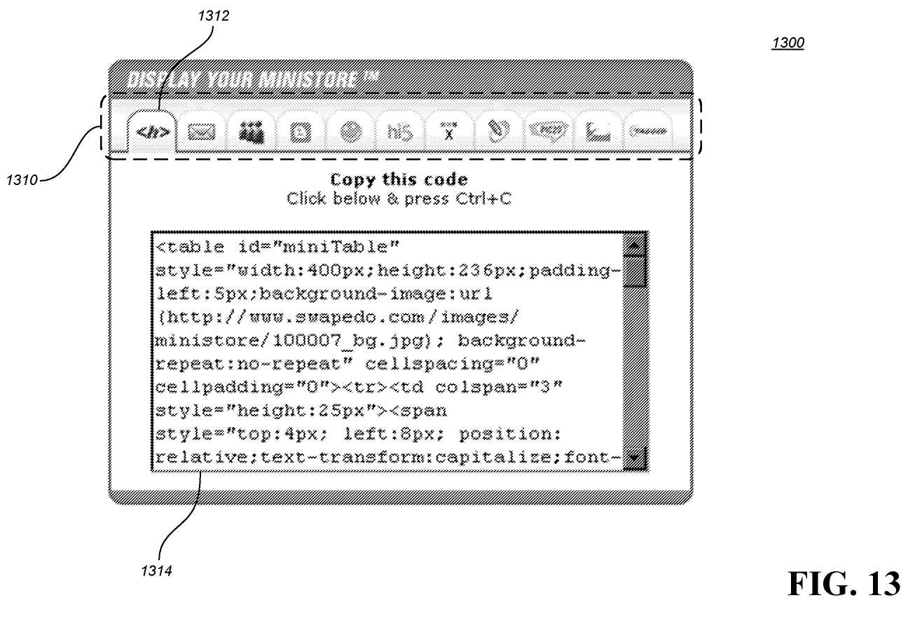

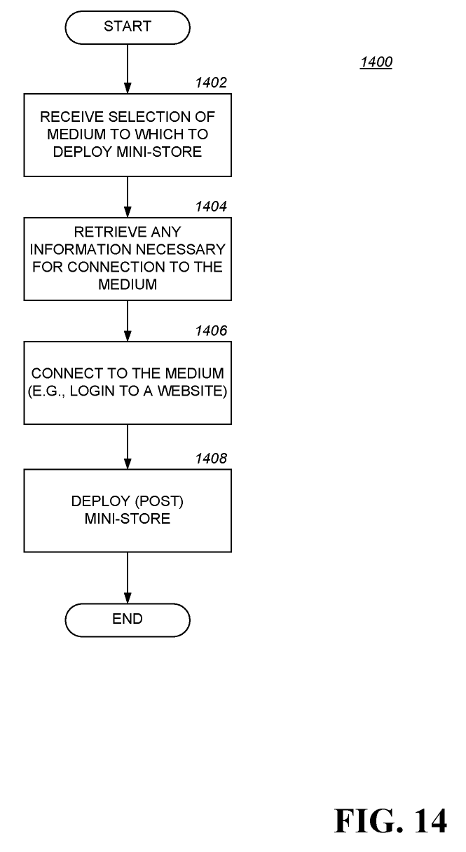

As discussed above, one aspect of the present invention provides for the simple deployment of any created mini-store by allowing the user to copy and paste the HTML code to any web page. In another preferred embodiment of the present invention, a mechanism referred to as a “mini-store placement tool” allows the user to deploy any created mini-store to any third-party website having a standardized format for which the user has an account. Reference is made to FIG. 13, where a mini-store placement tool GUI 1300 configured in accordance with one preferred embodiment of the present invention is illustrated. The mini-store placement tool GUI 1300 includes a plurality of tabs 1310, each of which offers the user the ability to deploy a mini-store through a particular communication medium. For example, as shown, an HTML tab 1312 of the mini-store placement tool GUI 1300 offers the user the ability to copy the HTML code for a created mini-store from a text field 1314. The HTML code can then be pasted into an appropriate location of a third-party website for display on the user's personal webpage, such as the user's personal profile page on MySpace.com. Although this approach is already simple and universal in its application, an even simpler mechanism is offered by the mini-store placement tool GUI 1300. This will be described with reference to FIG. 14, where a mini-store placement process 1400 is illustrated.

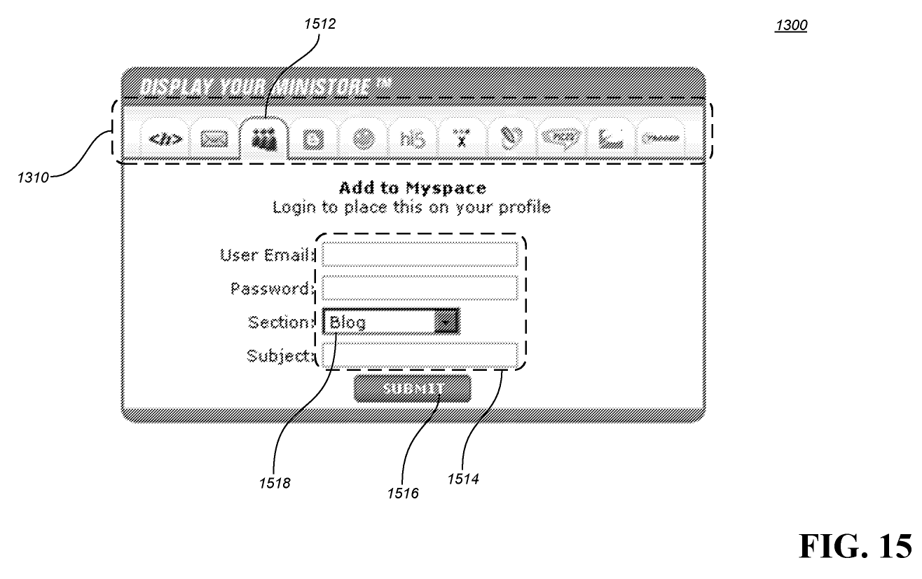

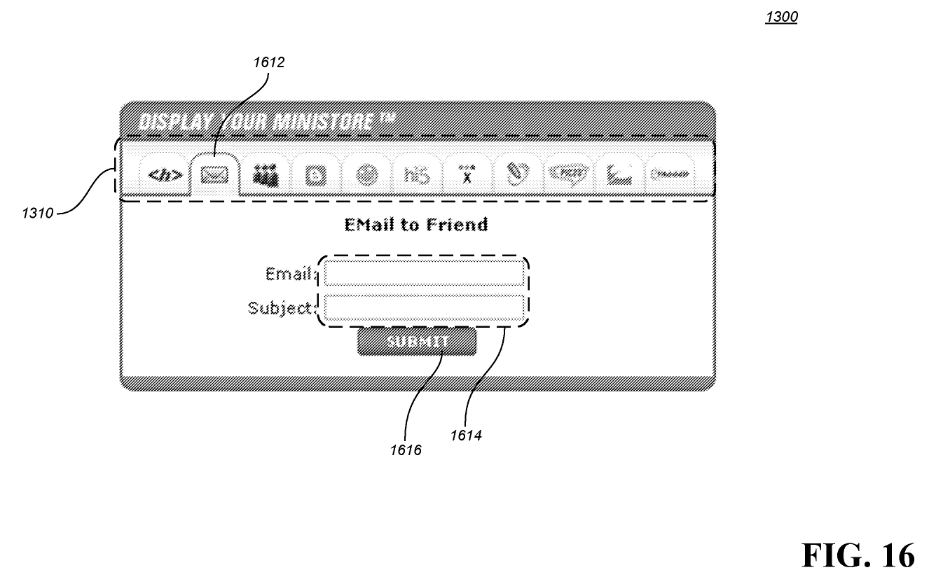

In step 1402, the user will select the website or communication medium to which the user wishes to deploy or “post” the mini-store. FIG. 15 illustrates the mini-store placement tool GUI 1300 where the user has selected a MySpace.com tab 1512 to post the mini-store to the user's MySpace.com personal profile page. FIG. 16 illustrates where the user has selected an e-mail tab 1612 to deploy the mini-store using e-mail. Other tabs in the plurality of tabs 1310 are configured to deploy the mini-store to other third-party websites as blogger.com, friendster.com, hi5.com, livejournal.com, piczo.com, tagged.com, typepad.com, and xanga.com. Once the selection of what communication medium the user wishes to deploy the mini-store has been received, operation then continues with step 1404. In the illustrated embodiment, the mini-store placement tool GUI 1300 does not illustrate the ability to allow the user to choose which created mini-store the user wishes to deploy. However, it should be noted that this selection may be made by the user at the beginning of the mini-store placement process 1400.

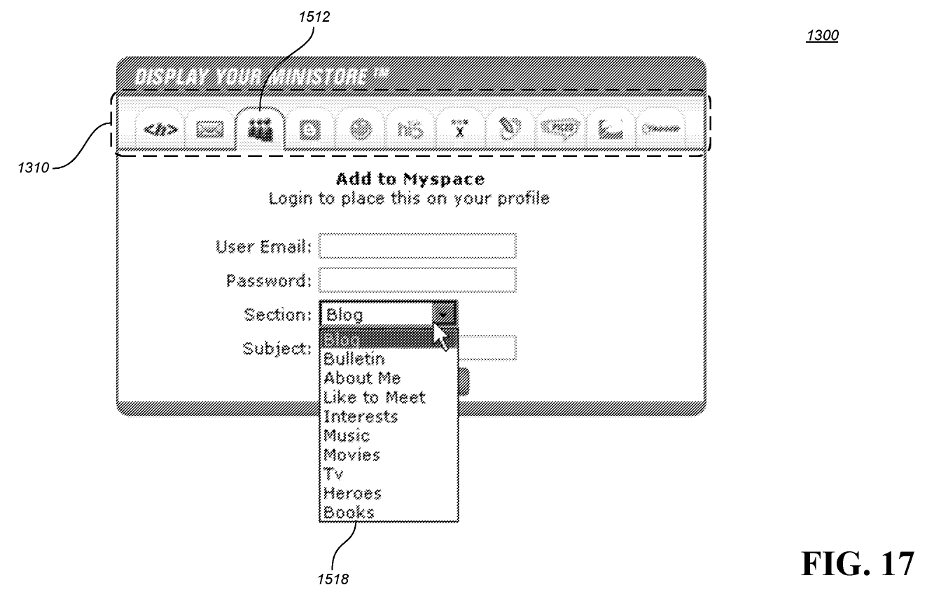

In step 1404, any information necessary to connect to the medium to deploy the mini-store is retrieved from the user. Referring again to FIG. 15, the MySpace.com tab 1512 includes a login information entry area 1514 where the user can input authentication information for logging into the user's account in MySpace.com. In addition, the login information entry area 1514 also include a “Section” pull-down menu 1518, as shown in FIG. 17, so that the user can specify the section on the user's MySpace.com profile under which the user wishes to post the mini-store, and a “Subject” text field for the user to enter a specific subject for the posting. Similarly, as shown in FIG. 16, the e-mail tab 1612 includes an information entry area 1614 where the user can input the e-mail address and subject of the e-mail containing the mini-store to be sent. A submit MySpace.com post button 1516 and a send e-mail button 1616 are provided on the MySpace.com tab 1512 and the e-mail tab 1612, respectively, for the user to submit the information to web server 110.

Once any connection information has been retrieved, operation continues with step 1406, where a connection is made to the medium (e.g., a login will be performed for the MySpace.com website) using the supplied connection information. Operation will then continue to 1408.

In step 1408, the mini-store code will be deployed to the medium. For example, the posting will be made to the MySpace.com website by the code being inserted into the proper area of the user's profile. In one preferred embodiment of the present invention, any existing code in the section in which the mini-store is to be deployed is appended so that any pre-existing code remains untouched. In another embodiment, the code is filtered so that no duplicates are created. In another embodiment, the code in the section is wiped out and replaced. In the case of the mini-store being posted in an e-mail message, an e-mail message will be sent to the e-mail address specified by the user.

As discussed herein, when loaded on a webpage of a third-party site, each mini-store is displayed in a sub-portion of the webpage and displays a subset of items as selected by the user during the configuration of the mini-store (e.g., the user mini-store record 136) from the complete user catalogue (e.g., the user catalogue 134). Further, if the predetermined set of items from the product catalogue is updated, in step 308 of the social network commerce implementation process 300, the display of all affected mini-stores will reflect the update in step 310.

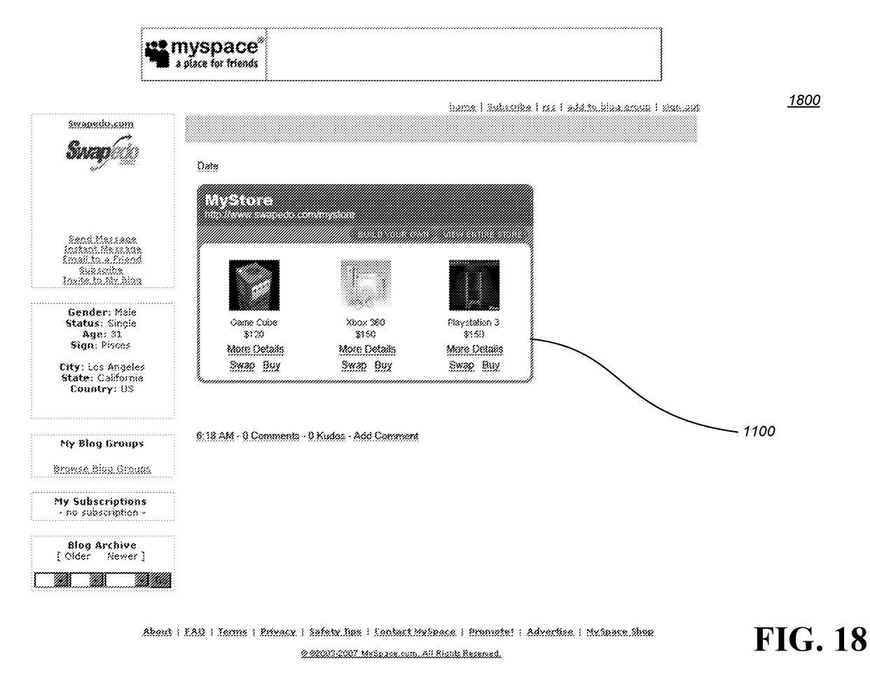

FIG. 18 illustrates the user mini-store GUI 1100 as posted on the user on a third-party website blog page 1800. Once the mini-store has been deployed, visitors to the user's personal profile web page on the third-party website will be able to access the items being promoted by performing an item selection action. For example, the user can click on the various links provided in the mini-stores (e.g., the “Swap”, “Buy”, or “More Details” links).

Referring again to the social network commerce implementation process 300 as shown in FIG. 3, if the web server 110 receives an item selection action from the user in step 312, operation will continue with step 314, where the web server 110 will process the item selection action.

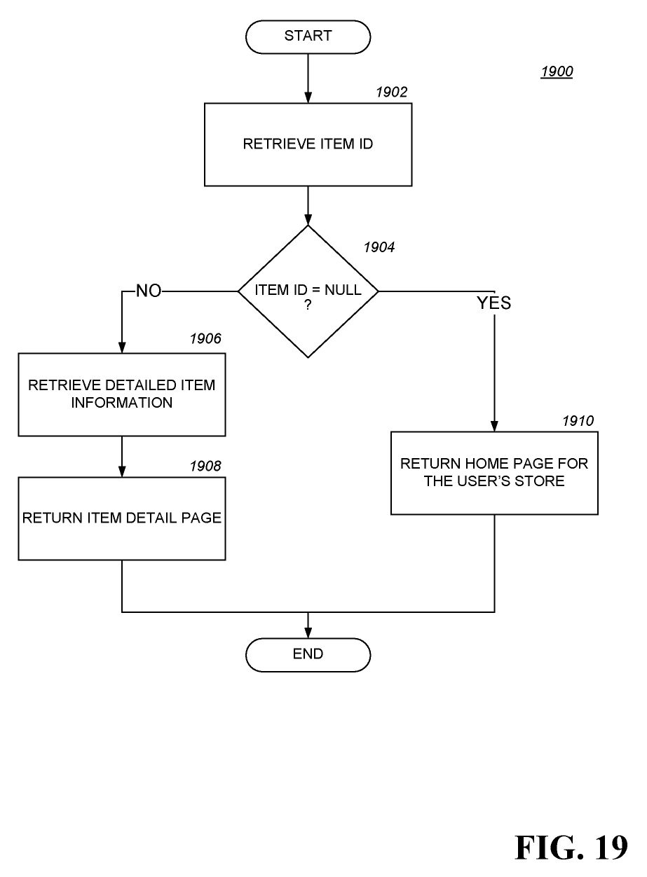

FIG. 19 illustrates an item selection process 1900 configured in accordance with one preferred embodiment of the present invention. As discussed above, when a visitor clicks on the links in the mini-store, web server 110 will receive a request containing information needed to retrieve the item identifier of the item of interest in the form of the file name of the image that is contained in the request. Specifically, the file name contains the UserID, the Mini-storeID, and the position number of the item in the mini-store record from which the item identifier can be determined. In step 1902, web server 110 will retrieve the item identifier. Operation will then continue with step 1904.

In step 1904, it is determined if the retrieved item identifier is a “valid” value. In other words, if the retrieved item identifier is a null value. As previously discussed, the user does not have to place an item into all spots of a mini-store. However, when a particular spot does not contain an item, a blank image (or a store logo image) will be displayed on the mini-store. For example, the user mini-store record 136 may only contain one item, the item identifier of which is stored in ItemID1. In this case, the other two item identifier fields, ItemID2 and ItemID3, will contain a null value, which may mean that those fields filled with a predetermined value designated as a null value (e.g., “000000”) or are left blank. An illustration of this mini-store configuration is shown in the mini-store GUI 1100 of FIG. 11. Thus, if the visitor clicks on the “MyStore LOGO” image in the mini-store GUI 1100, the retrieved item identifier will be a “null” value, and operation will continue with step 1910. Otherwise, if the user selects an item that is not null, operation will continue with step 1906.

In step 1906, the web server 110 will retrieve the detailed product information for the selected item based on the retrieved item identifier in a query to the database server 120. In one preferred embodiment of the present invention, the information is contained in the user catalogue (e.g., the user catalogue 134) stored in the catalogue database 124. Once the detailed product information has been retrieved, operation will continue with step 1908.

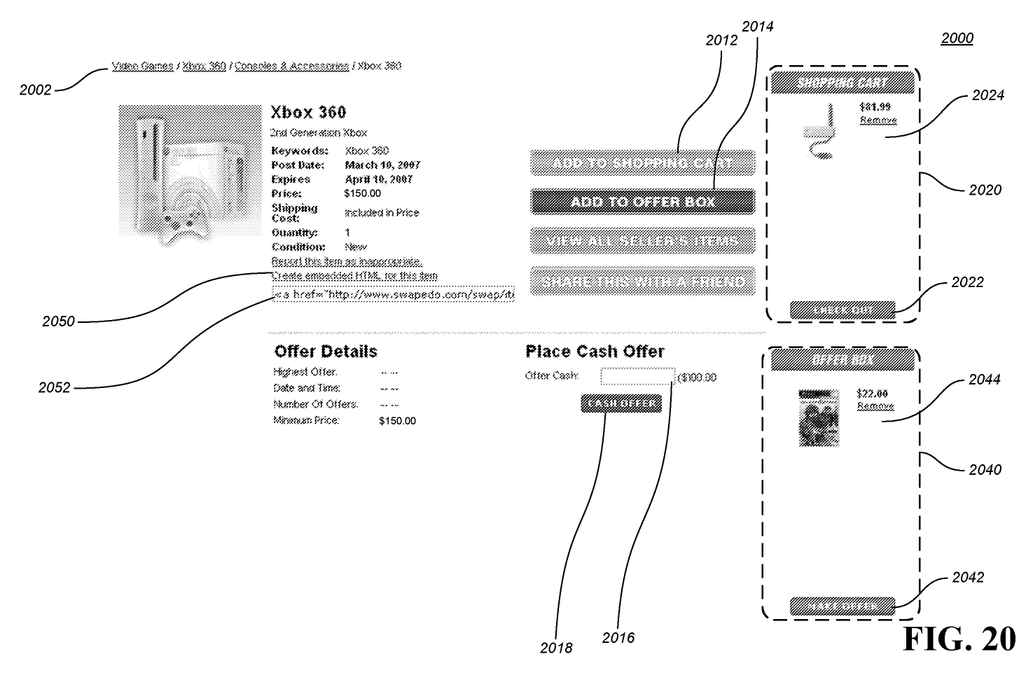

In step 1908, once the detailed information for the selected item has been retrieved from the user catalogue (e.g., the user catalogue 134), a product detail page will be returned to the visitor by the web server 110. FIG. 20 illustrates an item detail GUI 2000, configured in accordance with one preferred embodiment of the present invention, that is displayed on the browser of the visitor when the visitor has selected the “More Details” link for the “Xbox 360” item 1206 in the mini-store GUI 1100 of FIG. 12. The item detail GUI 2000 includes such product information such as a category detail 2002, as well as an “Add to Shopping Cart” button 2012, which allows the visitor to add the item to a shopping cart 2020; and an “add to offer box” button 2014, which allows the visitor to add the item to an offer box 2040. As illustrated, the shopping cart 2020 contains an existing item 2124 and a “Check Out” button 2122, the use of which will allow the visitor to check out and pay for the items in shopping cart 2120. Similarly, the offer box 2140 also contains a “Make Offer” button 2142, which allows the visitor to make offers (e.g., request to swap items, with or without a cash component) on the items in the offer box 2140, including an existing offer item 2144. The visitor may also place a cash offer by filling in an “Offer Cash” field 2016 and clicking a “Cash Offer” button 2018.

The item detail GUI 2000 also contains a “Create embedded HTML for this item” link 2050 that will display an item reference HTML code box 2052 on the item detail GUI 2000. In one preferred embodiment of the present invention, the HTML code contained in the item reference HTML code box 2052, if copied and pasted into a webpage, will display a GUI (not shown) with a link that can be selected by a visitor to the webpage to take the visitor to the detailed view of the product directly. An example of the HTML code is:

<a href=“http://www.swapedo.com/swap/item detail/ExampleItemID.jpg”><img src=“http://www.swapedo.com/images/embedded/ExampleItemID.jpg”/></a>,
where ExampleItemID can be used to retrieve the item identifier for the item. It is noted that in another preferred embodiment of the present invention, the mini-store placement tool described above with reference of deployment of mini-stores may also be used to deploy the HTML code for a single item.

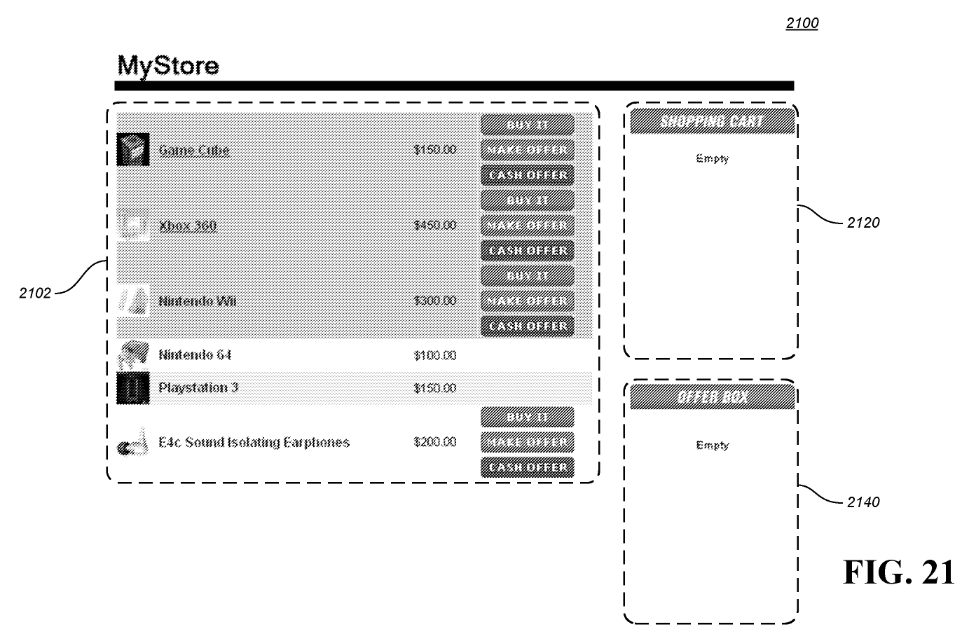

In step 1910, if the item selected by the user is a null item, the visitor will be brought to the home page of the store of the user. In one preferred embodiment of the present invention, the home page will list all items from the user catalogue 134. FIG. 21 illustrates a store home page 2100 configured in accordance with one preferred embodiment of the present invention, where a listing 2102 of all the items of the user is presented to the visitor along with a shopping cart 2120 and an offer box 2140.

Another aspect of the present invention is directed to a peer-to-peer item matching engine, by which items wanted by users may be matched up by items offered by other users in a dynamic process. In one preferred embodiment of the present invention, when a user finds an item of interest, the user can add the item to a list of items that the user wants to acquire, referred to herein as a “want list.” When the item is added by the user, the peer-to-peer item matching engine will query all the user catalogues in the catalogue database 124 and return a result of potential results to the user. The user can then outright purchase, offer a swap, or offer a cash bid for one or more of the items to the respective peer. In one preferred embodiment of the present invention, the user is presented with the option to add items to the want list when no search results are returned for an item search of all the items in the catalogue database 124.

The peer-to-peer item matching engine will periodically attempt to match the items in the users want lists and notify the user with the search results. In addition, a matching process may be initiated when a user adds an item to their user catalogue. For example, the user may add an item in the user's catalogue to offer that item for a sale or swap. When the item has been added, the peer-to-peer item matching engine will query the database server 120 for all the items that are sought after by the users of the system (i.e., the items contained in all want lists), and present the results to the user. The user can then be offered the functionality to contact the peers on the list, such as by e-mail to initiate a transaction. In one preferred embodiment of the present invention, the user can choose whether to make an item that the user is adding the user's catalogue available to wishlist peers—i.e., the user may want certain items to be limited from being available and thus be excluded from item matching by the peer-to-peer product matching engine.

Several mechanisms for the user to find or create an item entry in the user catalogue have already been discussed herein. It is noted that these mechanisms are equally applicable for users creating their want lists. In addition, another aspect of the present invention is a tool that allows users to obtain, or “scrape”, relevant product information from any webpage that the users are viewing. In one preferred embodiment of the present invention, the scrape tool is implemented as a plug-in or extension to existing software applications such as browsers, e-mail clients, or IM clients. In addition, the scrape tool can be implemented “universally” as an application that runs when the operating system loads, thereby providing the functionality over all applications.

In one preferred embodiment of the present invention, the scrape tool is a browser-based plug-in or extension that presents a tool bar interface and/or a menu interface. The user can select text on a webpage for an item of interest (i.e., an item that the user desires to either add to a catalogue to sell, swap or auction; or add to a want list to acquire by buying, swapping or bidding), and then select a button on the toolbar to indicate that the user wishes to add the item to a catalogue or want list. The selected text will then be used to retrieve product information, which will then be added to an appropriate list of the user.

In another preferred embodiment of the present invention, the scrape tool can filter the page to retrieve item information such as the manufacturer's product identifier, price, and description. For example, the scrape tool can be configured to decipher and filter an product detail page from a retail website such as amazon.com or buy.com to retrieve all relevant product information. The information retrieved by the scrape tool may either be directly added to the user catalogue or want list, or may be stored in temporary list to be edited by the user at a later time. In addition, a pop-up window may be displayed when the user uses the scrape tool to show the results of the scrape, which will then allow the user to edit the information and choose the destination of the information. For example, the pop-up may contain a GUI similar to the quick entry listing section 570 of the catalogue builder GUI 500 of FIG. 5, and include an “Add Item to Catalogue” button and an “Add Item to Want List” button. The interface may also include a pull-down or other selector menu if there are multiple catalogues or want lists to which the item may be added to allow the user to select a desired catalogue or list, respectively. In addition the toolbar, a context sensitive menu and submenus is added to the right-click menu that is brought up when the user clicks with the right (or secondary) mouse button anywhere on the webpage in the browser window displaying the item of interest.

The application plug-in/extension can provide mini-store placement tool-type functionality in another aspect of the invention. In one preferred embodiment of the present invention, the application plug-in/extension is customized for the software such that it will post information in a format that is context sensitive. For example, the application plug-in/extension that is implemented for a chat program will not normally insert the HTML code for mini-stores, but instead, will default to inserting only URLs. This is because most chat programs are not capable of rendering complex HTML code. Similarly, the application plugin/extension for a browser or an e-mail client may insert HTML code, such as the HTML code for mini-stores as webpages and emails are capable of utilizing this code and rendering it for display. Thus, for example, the application plug-in/extension can insert information (e.g., description, title, image, and link to display the product) for one or more of the products in a user's catalog or want list. In one preferred embodiment of the present invention, the available lists of the user (i.e., catalogues and want lists) are updated via a web feed format conforming to a standard referred to as a Really Simple Syndication (RSS) feed, version 2.0, as promulgated by the Berkman Center for Internet & Society at Harvard Law School. The plug-in/extension may also be notified of updates to the user's lists via other mechanisms, which may be scheduled or event-driven (e.g., when the user adds an item to a list).

It should be noted that the methods described herein may be implemented on a variety of hardware, processors and systems known by one of ordinary skill in the art. For example, the general requirement for the client to operate as described herein is that the client has a display to display content and information, a processor to control the operation of the client and a memory for storing data and programs related to the operation of the client. In one preferred embodiment of the present invention, the client is a personal computer. An exemplary client may be implemented using the computer system has already been described herein with reference to FIG. 2. In another preferred embodiment, the client is a handheld computer having communications capabilities. In yet another embodiment, the client is a cellular phone. The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The embodiments described above are exemplary embodiments. Those skilled in the art may now make numerous uses of, and departures from, the above-described embodiments without departing from the inventive concepts disclosed herein. Various modifications to these embodiments may be readily apparent to those skilled in the art, and the generic principles defined herein may be applied to other embodiments, without departing from the spirit or scope of the novel aspects described herein. Thus, the scope of the invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as the most preferred or advantageous over other embodiments. Accordingly, the present invention is to be defined solely by the scope of the following claims.

What is claimed is:

1. A system comprising:
a computer including:
a processor;
a memory coupled to the processor, the memory comprising computer-readable code that, when executed, will cause the processor to perform a method for offering a plurality of items for commerce, wherein each of the items in the plurality of items includes an item identifier usable to reference that item, the method comprising:
storing a first item identifier for the at least one of the plurality of items in a first predetermined location in a computer memory;
associating a first image with the at least one of the plurality of items;
assigning a first name to the first image based on the first predetermined location in the computer memory;
creating a first reference link comprising the first name assigned to the first image; and,
deploying the first reference link.

2. The system of claim 1, wherein deploying the first reference link comprising displaying the first reference link on a webpage to allow a user to copy and then paste the first reference link to a web page of the user in a third-party website.

3. The system of claim 1, wherein deploying the first reference link comprises:
receiving an identification of a communication medium through which the first reference link is to be deployed; and,
deploying the first reference link through the communication medium.

4. The system of claim 3, wherein the communication medium comprises a website.

5. The system of claim 4, wherein the identification of the communication medium includes authentication information for accessing a webpage of the user on the website, and posting the first reference link comprises:
submitting the authentication information to obtain access to the webpage of the user; and,
inserting the first reference link on the webpage of the user.

6. The system of claim 3, wherein the communication medium comprises an e-mail.

7. The system of claim 3, wherein the communication medium comprises an instant message.

8. The system of claim 1, wherein the method further comprising:
receiving a request to replace the at least one of the plurality of items with a replacement item from the plurality of items;
storing a replacement item identifier for the replacement item from the plurality of items in the first predetermined location in the computer memory;
associating a replacement image with the replacement item from the plurality of items; and,
assigning the first name to the replacement image based on the first predetermined location in the computer memory.

9. The system of claim 8, wherein the method further comprising removing the use of the first name with the first image.

10. The system of claim 1, wherein the method further comprising:
storing a second item identifier for a second one of the plurality of items in a second predetermined location in the computer memory;
associating a second image with the second one of the plurality of items;
assigning a second name to the second image based on the second predetermined location in the computer memory; and,
creating a second reference link comprising the second name assigned to the second image.

11. The system of claim 10, wherein deploying the first reference link comprising displaying the first reference link and the second reference link on a webpage to allow a user to copy and then paste the first reference link and the second link to a web page of the user in a third-party website.

12. The system of claim 10, wherein deploying the first reference link comprises:
receiving an identification of a communication medium through which the first reference link and the second reference link to be deployed; and,
deploying the first reference link and the second reference link through the communication medium.

13. The system of claim 10, wherein the second one of the plurality of items is a null item.

14. The system of claim 1, wherein the method further comprising:
receiving a request to retrieve item information based on the first reference link; and,
returning item information based on the first reference link.

15. The system of claim 14, wherein the request to retrieve item information based on the first reference link comprises the first name, and returning item information based on the first reference link comprises:
decoding the first name to locate the first predetermined location;
retrieving the first item identifier from the first predetermined location; and,
querying an item database to retrieve item information based on the first item identifier.

16. The system of claim 1, wherein the computer memory is a database record, and the first predetermined location is an item identification field in the database record.

17. The system of claim 1, wherein the first name comprises a user identifier.

18. The system of claim 1, wherein the first image is an image of the item.

19. The system of claim 1, wherein the plurality of items is a subset of larger grouping of items.

20. A method for offering a plurality of items for commerce, wherein each of the items in the plurality of items includes an item identifier usable to reference that item, the method comprising:
storing a first item identifier for the at least one of the plurality of items in a first predetermined location in a computer memory;
associating a first image with the at least one of the plurality of items;
assigning a first name to the first image based on the first predetermined location in the computer memory;
creating a first reference link comprising the first name assigned to the first image; and,
deploying the first reference link.

21. The method of claim 20, wherein deploying the first reference link comprising displaying the first reference link on a webpage to allow a user to copy and then paste the first reference link to a web page of the user in a third-party website.

22. The method of claim 20, wherein deploying the first reference link comprises:
receiving an identification of a communication medium through which the first reference link is to be deployed; and,
deploying the first reference link through the communication medium.

23. The method of claim 22, wherein the communication medium comprises a website.

24. The method of claim 23, wherein the identification of the communication medium includes authentication information for accessing a webpage of the user on the website, and posting the first reference link comprises:
submitting the authentication information to obtain access to the webpage of the user; and,
inserting the first reference link on the webpage of the user.

25. The method of claim 22, wherein the communication medium comprises an e-mail.

26. The method of claim 22, wherein the communication medium comprises an instant message.

27. The method of claim 20, further comprising:
receiving a request to replace the at least one of the plurality of items with a replacement item from the plurality of items;
storing a replacement item identifier for the replacement item from the plurality of items in the first predetermined location in the computer memory;
associating a replacement image with the replacement item from the plurality of items; and,
assigning the first name to the replacement image based on the first predetermined location in the computer memory.

28. The method of claim 27, further comprising removing the use of the first name with the first image.

29. The method of claim 20, further comprising:
storing a second item identifier for a second one of the plurality of items in a second predetermined location in the computer memory;
associating a second image with the second one of the plurality of items;
assigning a second name to the second image based on the second predetermined location in the computer memory; and,
creating a second reference link comprising the second name assigned to the second image.

30. The method of claim 29, wherein deploying the first reference link comprising displaying the first reference link and the second reference link on a webpage to allow a user to copy and then paste the first reference link and the second link to a web page of the user in a third-party website.

31. The method of claim 29, wherein deploying the first reference link comprises:
receiving an identification of a communication medium through which the first reference link and the second reference link to be deployed; and,
deploying the first reference link and the second reference link through the communication medium.

32. The method of claim 29, wherein the second one of the plurality of items is a null item.

33. The method of claim 20, further comprising:
receiving a request to retrieve item information based on the first reference link; and,
returning item information based on the first reference link.

34. The method of claim 33, wherein the request to retrieve item information based on the first reference link comprises the first name, and returning item information based on the first reference link comprises:
decoding the first name to locate the first predetermined location;
retrieving the first item identifier from the first predetermined location; and,
querying an item database to retrieve item information based on the first item identifier.

35. The method of claim 20, wherein the computer memory is a database record, and the first predetermined location is an item identification field in the database record.

36. The method of claim 20, wherein the first name comprises a user identifier.

37. The method of claim 20, wherein the first image is an image of the item.

38. The method of claim 20, wherein the plurality of items is a subset of larger grouping of items.

39. An apparatus comprising a computer-readable medium with instructions stored thereon that, when executed by a computer, causes the computer to execute a method for offering a plurality of items for commerce, wherein each of the items in the plurality of items includes an item identifier usable to reference that item, the method comprising:
storing a first item identifier for the at least one of the plurality of items in a first predetermined location in a computer memory;
associating a first image with the at least one of the plurality of items;
assigning a first name to the first image based on the first predetermined location in the computer memory;
creating a first reference link comprising the first name assigned to the first image; and,
deploying the first reference link.

40. The apparatus of claim 39, wherein deploying the first reference link comprising displaying the first reference link on a webpage to allow a user to copy and then paste the first reference link to a web page of the user in a third-party website.

41. The apparatus of claim 39, wherein deploying the first reference link comprises:
receiving an identification of a communication medium through which the first reference link is to be deployed; and,
deploying the first reference link through the communication medium.

42. The apparatus of claim 41, wherein the communication medium comprises a website.

43. The apparatus of claim 42, wherein the identification of the communication medium includes authentication information for accessing a webpage of the user on the website, and posting the first reference link comprises:
submitting the authentication information to obtain access to the webpage of the user; and,
inserting the first reference link on the webpage of the user.

44. The apparatus of claim 41, wherein the communication medium comprises an e-mail.

45. The apparatus of claim 41, wherein the communication medium comprises an instant message.

46. The apparatus of claim 39, wherein the method further comprising:
receiving a request to replace the at least one of the plurality of items with a replacement item from the plurality of items;
storing a replacement item identifier for the replacement item from the plurality of items in the first predetermined location in the computer memory;
associating a replacement image with the replacement item from the plurality of items; and,
assigning the first name to the replacement image based on the first predetermined location in the computer memory.

47. The apparatus of claim 46, wherein the method further comprising removing the use of the first name with the first image.

48. The apparatus of claim 39, wherein the method further comprising:
storing a second item identifier for a second one of the plurality of items in a second predetermined location in the computer memory;
associating a second image with the second one of the plurality of items;
assigning a second name to the second image based on the second predetermined location in the computer memory; and,
creating a second reference link comprising the second name assigned to the second image.

49. The apparatus of claim 48, wherein deploying the first reference link comprising displaying the first reference link and the second reference link on a webpage to allow a user to copy and then paste the first reference link and the second link to a web page of the user in a third-party website.

50. The apparatus of claim 48, wherein deploying the first reference link comprises:
receiving an identification of a communication medium through which the first reference link and the second reference link to be deployed; and,
deploying the first reference link and the second reference link through the communication medium.

51. The apparatus of claim 48, wherein the second one of the plurality of items is a null item.

52. The apparatus of claim 39, wherein the method further comprising:
receiving a request to retrieve item information based on the first reference link; and,
returning item information based on the first reference link.

53. The apparatus of claim 52, wherein the request to retrieve item information based on the first reference link comprises the first name, and returning item information based on the first reference link comprises:
decoding the first name to locate the first predetermined location;
retrieving the first item identifier from the first predetermined location; and,
querying an item database to retrieve item information based on the first item identifier.

54. The apparatus of claim 39, wherein the computer memory is a database record, and the first predetermined location is an item identification field in the database record.

55. The apparatus of claim 39, wherein the first name comprises a user identifier.

56. The apparatus of claim 39, wherein the first image is an image of the item.

57. The apparatus of claim 39, wherein the plurality of items is a subset of larger grouping of items.
